(19) United States
(12) Patent Application Publication
(10) Pub. No.: US 2024/0183778 A1
(43) Pub. Date: Jun. 6, 2024

(54) METHOD, APPARATUS AND SYSTEM FOR CHARACTERIZING TRANSIENT INTERACTIONS BETWEEN BIOMOLECULES

(71) Applicant: Helmholtz Zentrum München Deutsches Forschungszentrum für Gesundheit und Umwelt (GmbH), Neuherberg (DE)

(72) Inventors: Jian Cui, München (DE); Korneel Ridderbeek, München (DE)

(21) Appl. No.: 18/553,833

(22) PCT Filed: Apr. 7, 2022
(86) PCT No.: PCT/EP2022/059308

§ 371 Date: Oct. 3, 2023

(30) Foreign Application Priority Data
Apr. 8, 2021 (EP) 21167323.1

(51) Int. Cl. G01N 21/47

(52) U.S. Cl. CPC G01N 21/4738

(57) ABSTRACT

The invention relates to a method, an apparatus and system for characterizing transient interactions between biomoleules. wherein the method comprises following steps: providing a plurality of plasmonic nanoparticles which are configured to allow first biomolecules to adhere thereto: providing a mixture comprising the nanoparticles. first biomolecules and second biomolecules to allow the first biomolecules to adhere to the nanoparticles and to allow the second biomolecules to. in particular transiently, interact with the first biomolecules adherent to the nanoparticles: irradiating the mixture with first electromagnetic radiation, in particular broadband electromagnetic radiation: detecting second electromagnetic radiation, which is scattered by the mixture while irradiating the mixture with the first electromagnetic radiation, in a time-resolved and spectrally-resolved manner so as to obtain intensity signals representing changes in the spectrum of the detected second electromagnetic radiation: and determining at least one interaction parameter characterizing transient interactions of the second biomolecules with the first biomolecules based on the intensity signals.

The present invention relates to a method, apparatus and system for characterizing transient interactions, in particular rapid transient interactions, between biomolecules.

Biomolecular interactions form the foundation of nearly all cellular processes. However, many of these interactions occur on timescales that cannot be accessed using conventional methods, such as surface plasmon resonance (SPR). Nuclear magnetic resonance (NMR) can access the high temporal and spatial resolution needed to resolve these interactions, but NMR is generally limited to small biomolecules. Fluorescent dyes can be used via Förster resonance energy transfer (FRET) to potentially determine these interaction rates, however fluorescent methods are limited by emitter photobleaching and the need to specifically label biomolecules and remove unlabeled dyes.

The present invention is based on the problem of providing an improved method, apparatus and system for characterizing transient interactions, in particular rapid transient interactions, between biomolecules.

The problem is solved by a method and apparatus according to the independent claims and a system comprising such an apparatus.

According to a first aspect of the invention, a method for characterizing transient interactions between biomolecules comprises the following steps: providing a plurality of plasmonic nanoparticles which are configured to allow first biomolecules to adhere thereto; providing a mixture comprising the nanoparticles, first biomolecules and second biomolecules to allow the first biomolecules to adhere to the nanoparticles and to allow the second biomolecules to, preferably transiently, interact with the first biomolecules adherent to the nanoparticles; irradiating the mixture with first electromagnetic radiation, in particular broadband electromagnetic radiation; detecting second electromagnetic radiation, which is scattered by the mixture while irradiating the mixture with the first electromagnetic radiation, in a time-resolved and spectrally-resolved manner so as to obtain intensity signals, in particular intensity fluctuation signals, representing changes or fluctuations in the spectrum of, in particular wavelengths and/or energies contained in, the detected second electromagnetic radiation; and determining, based on the intensity signals, at least one interaction parameter characterizing transient interactions of the second biomolecules with the first biomolecules.

According to a second aspect of the invention, an apparatus for characterizing transient interactions between biomolecules comprises: a receptacle configured to receive a mixture comprising first biomolecules, second biomolecules and a plurality of plasmonic nanoparticles which are configured to allow at least a part of the first biomolecules to adhere thereto, wherein at least a part of the second biomolecules are allowed to, in particular transiently, interact with first biomolecules adherent to the nanoparticles; an irradiation unit configured to irradiate the mixture with first electromagnetic radiation, in particular broadband electromagnetic radiation, a detection unit configured to detect second electromagnetic radiation such as white light, which is scattered by the mixture while being irradiated with the first electromagnetic radiation, in a time-resolved and spectrally-resolved manner so as to obtain intensity signals, in particular intensity fluctuation signals, representing changes and/or fluctuations in the spectrum of, in particular of the wavelengths and/or energies contained in, the detected second electromagnetic radiation; and a processing unit configured to determine, based on the intensity signals, at least one interaction parameter characterizing transient interactions of the second biomolecules with the first biomolecules.

According to a third aspect of the invention, a system for characterizing transient interactions between biomolecules comprises an apparatus according to the second aspect of the invention and i) a plurality of plasmonic nanoparticles which are configured to allow first biomolecules to adhere thereto and/or ii) a mixture comprising a plurality of plasmonic nanoparticles, which are configured to allow first biomolecules to adhere thereto, first biomolecules and second biomolecules.

Aspects of the invention are preferably based on the approach of using plasmonic nanoparticles as local sensors for sensing fast transient interactions between biomolecules. Plasmonic nanoparticles are particles made out of a, preferably metallic, material with dimensions preferably smaller than 1 μm (<10⁻⁶ m). The high density of electrons in these particles can resonate with light incident on the particles generating so-called localized surface plasmon resonances (LSPRs). At this resonance, the electromagnetic waves are confined tightly around the particle, making the resonance very sensitive to changes in the local dielectric environment. Due to this effect, the optical response changes as a function of a changing environment, so that plasmonic nanoparticles act as local (refractive index) sensors, wherein interacting molecules, for example proteins, around the nanoparticles change the optical output of the nanoparticles. For further details regarding the use of plasmonic nanoparticles as local refractive index sensors it is referred to Maier, S. A., Plasmonics: fundamentals and applications, Springer Science & Business Media (2007). This local sensitivity of plasmonic nanoparticles implies that the optical output of the nanoparticle reflects the dynamics of events occurring around the particles. Therefore, the scattering signal of plasmonic nanoparticles can be used to study and characterize biomolecular interactions. Using the scattering of such particles yields orders of magnitude more signal than fluorescent emitters, because they are not limited to by “slow” absorption-emission photophysics and by photobleaching of dyes. In a preferred application, a biomolecule of interest A is immobilized on the nanoparticle surface, then biomolecule B is added to the mixture, light is shone on the sample, and the resulting scattering light is collected.

Within the meaning of present disclosure, the term “transient interaction(s)” and its variations, such as “transiently interact” or “interact transiently”, preferably relate to any non-stable and/or temporary and/or non-permanent and/or reversible interaction between biomolecules (being preferably in a thermal equilibrium), in particular in distinction to a non-transient and/or stable and/or permanent and/or irreversible interaction, in particular binding, of biomolecules. For example, a transient interaction between biomolecule A and biomolecule B means that A and B interact, e.g. bind and/or associate and/or are in a bound state, for a usually very short time, before reversibly dissociating to an unbound state and so on. In contrast to this, a non-transient interaction between A and B means that, once A and B are in a bound state or an according chemical reaction is completed, A and B remain in the bound state.

Basically, the method, apparatus and system according to present disclosure can be used in any kind of biological, medical and/or industrial application, for example as an analytical tool in the field of protein biology or for drug screening. Drug screening is the process by which potential drugs are identified and optimized before selection of a candidate drug to progress to clinical trials. It can involve screening large libraries of chemicals for a particular biological activity in high-throughput screening assays.

In a preferred implementation of this approach, plasmonic nanoparticles and biomolecules to be investigated are contained in a mixture, which is preferably in a thermal equilibrium, in particular a solution and/or dispersion, to allow first biomolecules to adhere to the surface of the nanoparticles, on the one hand, and to allow second biomolecules to transiently interact with the first biomolecules adherent to the nanoparticles, on the other hand. That is, while the components (i.e. a plurality of nanoparticles and biomolecules) according to present implementation are preferably dispersed in a solution or dispersion, respectively, conventional methods look at interactions happening on extended surfaces, where e.g. single nanoparticles are immobilized on an extended surface, e.g. a glass surface. Thus, while nanoparticles and biomolecules dispersed in a solution or dispersion can more or less freely interact with each other, biomolecule-nanoparticle interactions happening on extended surfaces may be strongly influenced by disruptions in diffusion due to the presence of the extended surface.

The mixture is irradiated with first electromagnetic radiation, in particular broadband electromagnetic radiation such as white light, and second electromagnetic radiation, which is scattered by the mixture while being irradiated with first electromagnetic radiation, is detected over time or as a function of time (i.e. “time-resolved”) and for different wavelengths or energies (i.e. “spectrally-resolved”) so as to obtain intensity signals, whereby fluctuations in the intensity signals (also referred to as “intensity fluctuations”) represent and/or contain information about changes and/or fluctuations of wavelengths or energies contained the spectrum the second electromagnetic radiation. By analyzing the intensity signals, at least one interaction parameter which, in particular quantitatively, characterizes fast transient interactions between the first and second biomolecules can be determined. For example, transition rates kₒₙ, K_{off} between states, e.g. from bound to unbound state and vice versa, and/or the dissociation constant K_{D}, can be determined even on sub-millisecond timescales. In this way, it is possible to characterize fast transient biomolecular interactions typically unresolved in conventional measurements. That is, while conventional methods suffer from the adverse effects of surface-immobilization of nanoparticles, limited time resolution and undesired heating from single-particle measurements, present implementation uses a statistical analysis of interactions occurring in a mixture, in particular dispersion, of a plurality of nanoparticles and biomolecules to allow for an improved quantitative characterization of rapid transient interactions between biomolecules with very high sensitivity and exceptionally high time resolution.

In summary, the invention allows for characterizing, in particular quantitatively characterizing, rapid transient interactions between biomolecules, which are preferably contained in a mixture and/or solution, with very high sensitivity and time resolution.

Within the present disclosure, the term “biomolecule” preferably relates to any kind of biological molecules, such as molecules present in organisms that are essential to one or more typically biological processes, such as cell division, morphogenesis, or development. For example, the term “biomolecule” includes large macromolecules such as proteins, carbohydrates, lipids, and nucleic acids, as well as small molecules such as primary metabolites, secondary metabolites and natural products.

Preferably, the mixture can be obtained by mixing the plasmonic nanoparticles and the first biomolecules to allow first biomolecules to adhere to the nanoparticles, and then adding second biomolecules to allow second biomolecules to transiently interact with the first biomolecules adherent to the nanoparticles. Preferably, the mixture is in a thermal equilibrium. In this manner, the mixture is closer to real physiological conditions than with methods based on a non-equilibrium mixing. Alternatively, it is also possible to obtain the mixture by pouring together and/or mixing the plasmonic nanoparticles and the first and second biomolecules simultaneously, or by mixing the first and second biomolecules and then adding the plasmonic nanoparticles.

Within the meaning of present disclosure, the term “dispersion” in which the plasmonic nanoparticles and biomolecules to be investigated are preferably contained, preferably relates to any heterogeneous mixture of substances comprising the plasmonic nanoparticles, also referred to as “colloidal nanoparticles”, the biomolecules, and a dispersion medium or dispersing agent (e.g. water), wherein at least two of the substances do not or hardly dissolve in each other. In the so-called disperse phase, the plasmonic nanoparticles and the biomolecules are finely dispersed in the dispersion medium or agent.

Within the meaning of present disclosure, the term “solution” in which the plasmonic nanoparticles and biomolecules to be investigated are preferably contained, is used synonymously to the term “dispersion” and vice versa, unless otherwise stated.

According to a preferred embodiment, the step of detecting the second electromagnetic radiation comprises: splitting the second electromagnetic radiation into a first partial beam and a second partial beam; providing one or more different path length differences between the first partial beam and the second partial beam; superimposing the first partial beam and the second partial beam for each of the path length differences so as to obtain a first interference beam and a second interference beam for each of the path length differences; and separately detecting the first interference beam and the second interference beam by means of two separate detectors at different times and for each of the path length differences so as to obtain two series of intensity signals representing intensities of the first interference beam and second interference beam, respectively, at the different times and for the different path length differences.

For example, the second electromagnetic radiation can be directed to a Michelson interferometer, which comprises a beam splitter that splits the second electromagnetic radiation into the first and second partial beam and a movable arm for providing different path length differences. However, within the scope of this embodiment, any kind of a beam splitting device and/or path-length-difference generator can be used. For example, instead of a Michelson interferometer a so-called “common-path interferometer” can be used which does not split the beam but still provides an optical path length difference.

Preferably, the path-length-difference generator may comprise a reflecting element mounted on a movable stage provided in one of the interferometer arms. Preferably, the stage is slowly moving (also referred to as “scanning”) and/or stepping (i.e. moving stepwise or pointwise from one point or position to another point or position) during the acquisition, that is during the step of detecting the second electromagnetic radiation. In this way, the path length difference is changing continuously and/or stepwise or pointwise, respectively, while the second electromagnetic radiation (including information about the correlation function) is being detected.

Preferably, the reflecting element and/or stage is moved stepwise or pointwise through the interferometer, wherein the intensities of the first and second interference beam are measured for each position of the reflecting element and/or stage so as to obtain an interferogram from each of the interference beams. Additionally, at each position of the reflecting element and/or stage (i.e. after each step), the interferometer stage performs a periodic motion. This is done to measure the envelope of the interferogram instead of all individual fringes. Preferably, the width of a step is between 0,1 μm to 10 mm. Preferably, the amplitude of the periodic motion is 300 to 800 nm, preferably approx. 500 nm.

Preferably, the two separate detectors can be any kind of fast optical detectors, for example, so-called single-photon detectors or single-photon counters, which provide a very fast time resolution even for weak signal intensities.

According to an alternatively preferred embodiment, the step of detecting the second electromagnetic radiation comprises: applying the second electromagnetic radiation to at least one spectral splitting element, preferably a dichroic optical element, preferably a dichroic reflector, in particular a dichroic mirror, a beam splitter and two band-pass filters or long-pass and short-pass combination or two monochromators, so as to obtain at least one first partial beam of electromagnetic radiation having a first spectrum and/or wavelength(s) and at least one second partial beam of electromagnetic radiation having a second spectrum and/or wavelength(s) which is different from the first spectrum; and separately detecting the first partial beam and the second partial beam by means of two separate detectors at different times so as to obtain two series of intensity signals representing intensities of the first partial beam and second partial beam, respectively, at the different times and for the first and second spectrum.

Other than the previously described preferred embodiment, this alternatively preferred embodiment does not rely on interferometric effects or require an interferometer in the narrower sense. Rather, the interferometer is exchanged with a spectral splitting element, preferably a dichroic reflector or mirror or a beam splitter and two band-pass filters or long-pass and short-pass combination or two monochromators, which generates two partial beams of different wavelengths, spectra and/or different colors, preferably by splitting the scattering spectrum in half. This is why this approach is also referred to as “dual color method”. By separately detecting the two partial beams as a function of time, the change in numbers of photons arriving on either detector is determined. This number then reflects biomolecular dynamics. As with the preferred embodiment described above, the two separate detectors can be any kind of fast optical detectors, for example so-called single-photon detectors or single-photon counters, which provide a very fast time resolution even for weak signal intensities.

Preferably, at least one time auto-correlation function is determined which characterizes a time auto-correlation of a combination (also referred to as “total stream”) of the two series of intensity signals, wherein at least one diffusion parameter characterizing a diffusion of the nanoparticles in the mixture is determined based on the at least one time auto-correlation function. Preferably, within the meaning of present disclosure, the term “time auto-correlation function” relates to an intensity-time auto-correlation function, which can also be referred to as “intensity auto-correlation function”.

Preferably, at least one time cross-correlation function is determined which characterizes a time cross-correlation between the two series of intensity signals, wherein the at least one interaction parameter characterizing the transient binding behavior is determined based on the at least one time cross-correlation function and, optionally, also on the at least one time auto-correlation function and/or the at least one diffusion parameter characterizing the diffusion of the nanoparticles in the mixture. Preferably, within the meaning of present disclosure, the term “time cross-correlation function” relates to an intensity-time cross-correlation function which can also be referred to as “intensity cross-correlation function”.

It is further preferred that the at least one time auto-correlation function and/or the at least one time cross-correlation function is determined for the different path length differences between the first partial beam and the second partial beam (in case of an interferometric measurement setup) or for the first and second spectrum (in case of the dual-color method), respectively. In case of the interferometric setup, the path length differences preferably correspond to averaged path length difference which are obtained during scanning by averaging over a small range of path length differences.

Preferably, the time auto-correlation function (i.e. the intensity-time auto-correlation function or intensity auto-correlation function) is used to correct the time cross-correlation function (i.e. the intensity-time cross-correlation function, intensity cross-correlation function) to remove effects of nanoparticle diffusion on the time cross-correlation function. In other words, the intensity auto-correlation function is used to correct the intensity cross-correlation function. This removes the effects of nanoparticle diffusion and isolates the effects of sensing. The corrected cross-correlation functions can then be studied in the time domain (as they are) or in the spectral domain (after Fourier transform, see below). This is particularly advantageous compared to conventional surface-based methods as it enables looking at freely diffusing nanoparticles over a broad range of timescales.

In some applications or circumstances, it may be possible that the at least one interaction parameter is determined based, in particular based only, on the corrected intensity cross-correlation function. In other words, in some applications or circumstances it is possible to use or only use the corrected intensity cross-correlation function to obtain the interaction parameters, in particular without needing and/or calculating the full spectral correlation function (as described in detail below).

In other applications or circumstances, it may be preferred to use more than one or even many corrected cross-correlations to construct the spectral correlation function to get a more complete picture of the ongoing transactions. For example, the magnitude of nanoparticle spectral shifts and their dynamics along with the dynamics of proteins around them are reflected in the spectral correlation function. This information can be used to determine the proximity, size, etc. of the proteins under investigation and is especially pertinent in more complicated and/or mixed systems. In other words: The full spectral correlation function gives a complete view of the magnitude of energy shifts and their timescale of the nanoparticle, which can then be related to biomolecular interactions. Alternatively, the same information can be obtained from a single corrected cross-correlation function if certain assumptions hold. The validity of these assumptions can be verified from the complete spectral correlation.

Preferably, the time cross-correlation functions, which are determined for the different path length differences, and/or the corrected cross-correlation functions (see above) are being Fourier transformed, preferably by means of a one-dimensional Fourier transformation with respect to the dimension of the path length differences, so as to obtain spectral correlation functions at different times (i.e. time lags) and for different energy or wavelength changes (i.e. energy or wavelength shifts, respectively), wherein the at least one interaction parameter, in particular the transition rate(s) Kₒₙ and/or K_{off}, is determined based on the spectral correlation functions. Preferably, within the meaning of present disclosure, the term “spectral correlation function” relates to a spectral-time correlation function.

Preferably, a temporal behavior of the spectral correlation functions is determined, wherein the at least one interaction parameter, in particular the transition rate(s) Kₒₙ and/or K_{off}, is determined based on the temporal behavior of the spectral correlation functions. Preferably, the determined temporal behavior of the spectral correlation functions relates to a change of magnitude or shape, e.g. width, of the spectral correlation and/or a decay of a maximum at a given energy or wavelength.

Preferably, the at least one interaction parameter, which contains biomolecular dynamic information such as kₒₙ, K_{off} and/or K_{D}, is obtained by analyzing the obtained temporal change of the spectral correlation or diffusion-corrected cross-correlation for the dual-color method and alternative PCFS methods.

Preferably, the at least one interaction parameter, which contains biomolecular dynamic information such as kₒₙ, K_{off} and/or K_{D}, is obtained by fitting at least one function reflecting the biomolecular dynamics to the obtained spectral correlation change or diffusion-corrected cross-correlation change for the dual-color method and alternative PCFS methods as a function of time. The at least one function can be, e.g., an exponentially decaying function.

Preferably, the at least one function reflecting the biomolecular dynamics is obtained based on a model, in particular a computational model, wherein biomolecular interactions occurring in the proximity of the sensing nanoparticles are simulated. Alternatively to simulating the biomolecular interactions, the at least one function reflecting the biomolecular dynamics can be obtained based on an interaction model, which is based on theoretical assumptions, e.g. including two, three, five or multitude of states, regarding the biomolecular interactions.

Preferably, the model is based on a two-state model according to which a binary interaction can be described by two states, wherein the biomolecules are either attached or detached with forward and backwards rates dictating the timescale of change. A computer simulation can mimic this system by defining two distinct peaks in the spectrum, one corresponding to the “on state” and the other to the “off state”.

Preferably, determining the at least one interaction parameter, such as kₒₙ, K_{off}, K_{D}, includes determining at least one parameter characterizing reversible interactions between the first and second biomolecules.

Preferably, determining the at least one interaction parameter, such as kₒₙ, K_{off}, K_{D}, includes determining at least one of the following: i) a first transition rate Kₒₙ characterizing a time rate at which transitions occur between an unbound state, in which the second biomolecules are not bound to and/or do not interact with first biomolecules, to a bound state, in which the second biomolecules are bound to and/or interact with the first biomolecules; and/or ii) a second transition rate K_{off} characterizing a time rate at which transitions occur between a bound state, in which the second biomolecules are bound to and/or interact with the first biomolecules, to an unbound state, in which the second biomolecules are not bound to and/or do not interact with the first biomolecules; and/or iii) a dissociation constant K_{D} characterizing a tendency of the first and second biomolecules to reversibly dissociate between a bound state, in which the second biomolecules are bound to and/or interact with the first biomolecules, and an unbound state, in which the second biomolecules are not bound to and/or do not interact with the first biomolecules.

Preferably, the mixture comprising the nanoparticles, first biomolecules and second biomolecules is a solution and/or dispersion, wherein the nanoparticles, first biomolecules and second biomolecules are dissolved in a solvent or dispersed in a dispersion agent, respectively.

Preferably, the nanoparticles are chosen such that their sensitivity is high, e.g. to detect single interaction events. Basically, various shapes of the nanoparticles are suitable for this purpose. For example, the nanoparticles have a shape exhibiting multiple sharp tips. For example, the nanoparticles can have a polyhedral shape, e.g. the shape of a cube. Preferably, the nanoparticles have a non-rod-like shape.

Preferably, the irradiation unit is configured to generate first electromagnetic radiation, which is suitable to cause and/or excite a localized surface plasmon resonance (LSPR) of the nanoparticles, preferably to stimulate a localized resonant oscillation of conduction electrons at the surface of the nanoparticles. Preferably, one or more wavelengths or frequencies of the first electromagnetic radiation match, in particular is or are equal to, one or more wavelengths or frequencies, respectively, of the surface plasmon resonance.

For example, the irradiation unit comprises a laser, preferably a white light laser, or another source, for example a lamp, which is configured to generate the first electromagnetic radiation.

Preferably, the irradiation unit is configured to generate pulsed first electromagnetic radiation. Preferably, the first electromagnetic radiation comprises pulses having a pulse length and a pulse repetition rate, wherein the pulse length and/or the reciprocal value of the pulse repetition rate is shorter, in particular much shorter, than the interaction time of the biomolecules. Alternatively, pulses that are much longer could be used. Alternatively, the irradiation unit may be configured to generate continuous first electromagnetic radiation so as to irradiate the mixture with continuous electromagnetic radiation.

Preferably, the irradiation unit comprises at least one focusing element, for example an objective lens and/or a microscope objective, which is configured to focus the first electromagnetic radiation to the mixture. Preferably, in the case that the irradiation unit comprises a laser, a beam focus, also referred to as “beam waist”, of the focused first electromagnetic radiation is positioned or located at a finite distance above or from, respectively, a surface of sample holder or receptacle and/or positioned or located inside the sample holder or receptable away from its walls or surfaces, respectively. Preferably, the “beam waist” is also configured in such a way that on average only a few nanoparticles are hit by it. Because the nanoparticles diffuse out of the laser focus, the duration of irradiation of the particles, and therefore plasmonic heating which is a disadvantage of conventional single plasmonic particle measurements, is limited. In other words: The beam focus is preferably located (deep) inside of the solution. Due to a small focus, only a few nanoparticles are irradiated at a time for only short time periods because they diffuse in and out. In this way, no individual nanoparticle heats up very much and the biomolecular interactions are not perturbed.

According to a preferred embodiment of the apparatus, the detection unit comprises: a beam splitter configured to split the second electromagnetic radiation into a first partial beam and a second partial beam; a path length difference generating unit, in particular a reflecting element mounted on a movable stage, such as a motorized linear stage, configured to provide one or more different path length differences between the first partial beam and the second partial beam, wherein the first partial beam and the second partial beam are allowed to superimpose for each of the path length differences so as to obtain a first interference beam and a second interference beam for each of the path length differences; and two separate detectors, for example single-photon detectors, photon time tagging devices, photomultiplier tubes (PMTs) or Avalanche photodiodes (APDs), which are configured to separately detect the first interference beam and the second interference beam at different times and for each of the path length differences so as to obtain two series of intensity signals representing intensities of the first interference beam and second interference beam, respectively, at the different times and for the different path length differences.

According to an alternatively preferred embodiment of the apparatus, the detection unit comprises: at least one spectral splitting element, preferably a dichroic optical element, in particular a dichroic reflector or mirror or a dichroic filter or a beam splitter with two filters, configured to reflect and/or transmit, respectively, the second electromagnetic radiation so as to obtain at least one first partial beam of electromagnetic radiation having a first spectrum (wavelength(s)) and at least one second partial beam of electromagnetic radiation having a second spectrum (wavelength(s)) which is different from the first spectrum; and two separate detectors, for example single-photon detectors, photon time tagging devices, photomultiplier tubes (PMTs) or Avalanche photodiodes (APDs), which are configured to separately detect the first partial beam and the second partial beam at different times so as to obtain two series of intensity signals representing intensities of the first partial beam and second partial beam, respectively, at the different times and for the first and second spectrum.

Preferably, the at least one spectral splitting element, preferably the dichroic optical element, is configured to reflect and/or transmit the second electromagnetic radiation such that one or more wavelengths or frequencies of the first spectrum and/or of the second spectrum match, in particular is or are equal to, one or more wavelengths or frequencies, respectively, of the surface plasmon resonance.

Further advantages, features and examples of present disclosure will be apparent from the following description of figures showing:

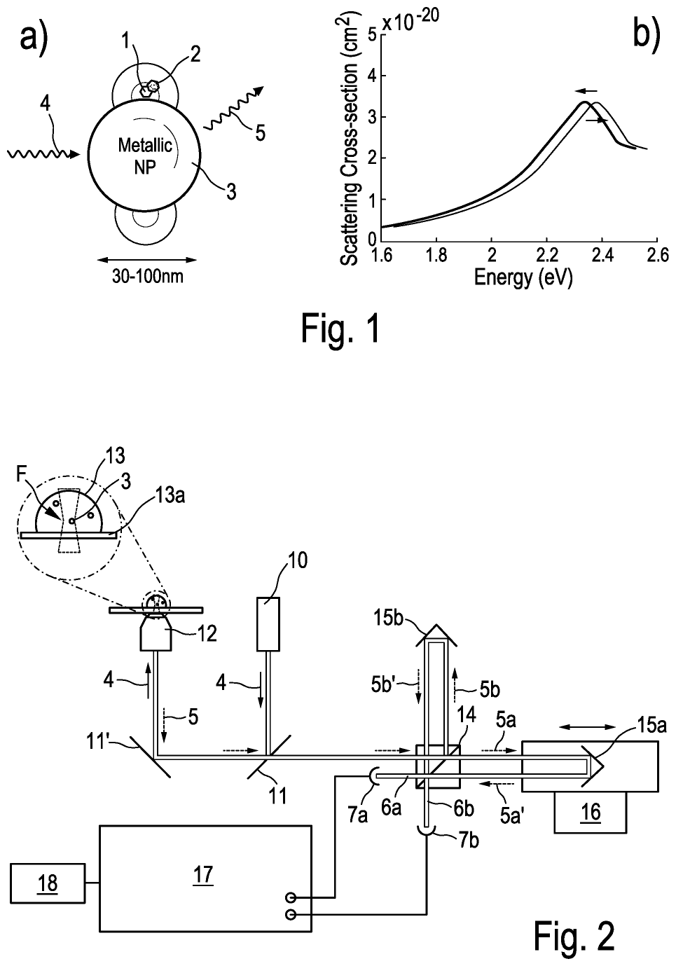

FIG. 1 (a) a schematic representation illustrating an interaction between biomolecules near the surface of a plasmonic nanoparticle and (b) its effect on the scattering cross-section;

FIG. 2 a schematic representation of an example of an apparatus for characterizing transient interactions between biomolecules;

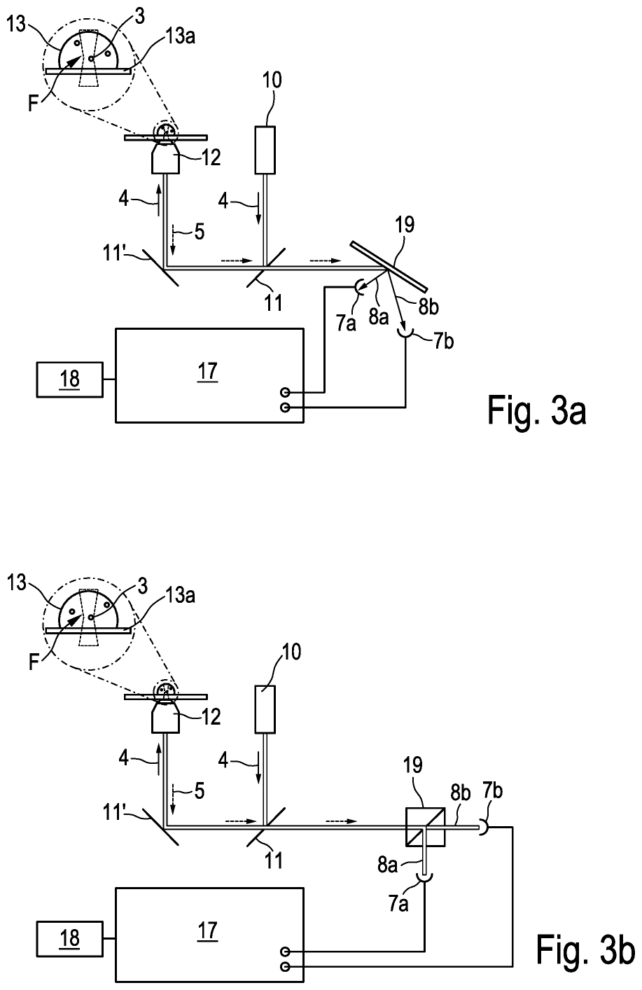

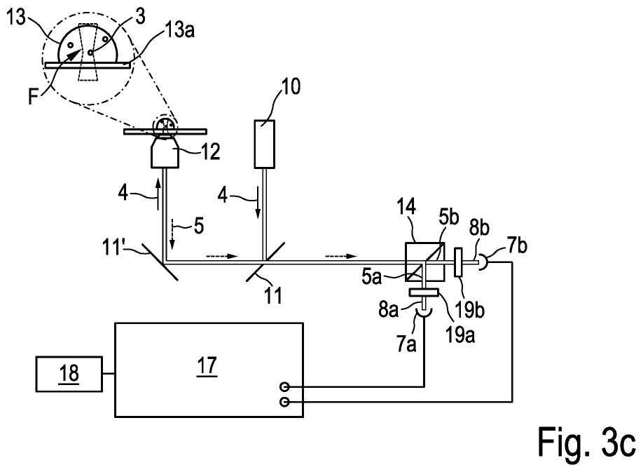

FIG. 3 (a) to c) schematic representations of examples of alternative setups of an apparatus for characterizing transient interactions between biomolecules;

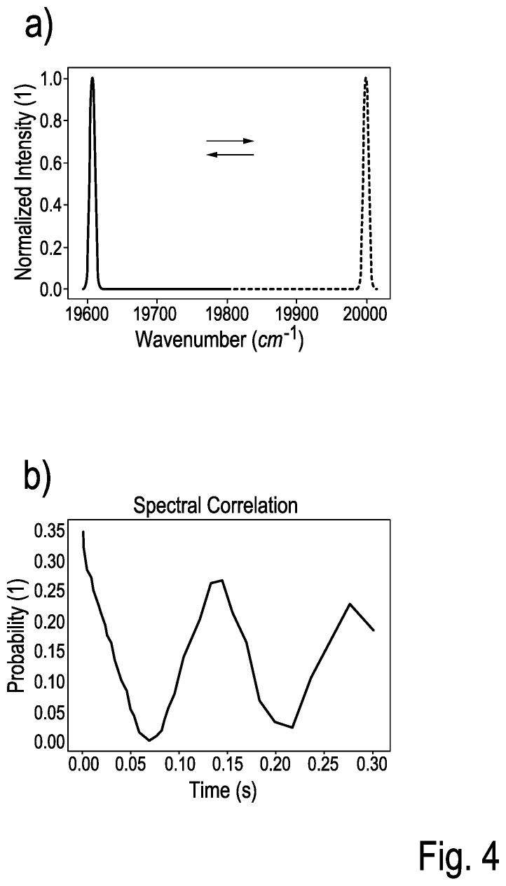

FIG. 4 (a) spectral data of a tunable laser and (b) a data analysis (spectral correlation versus time) revealing the timescale of the shifting spectrum;

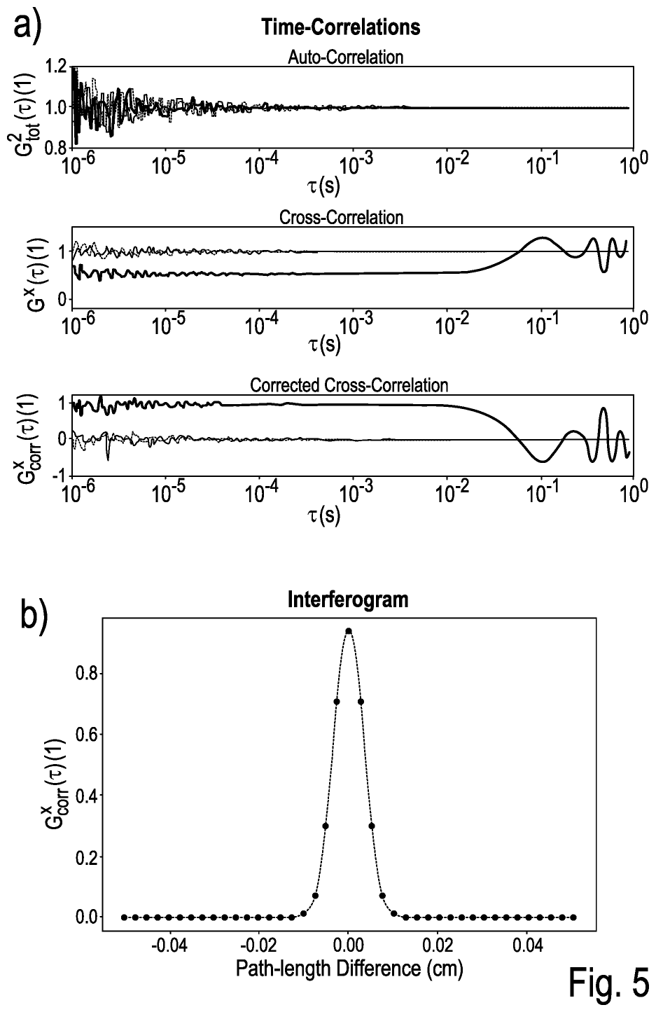

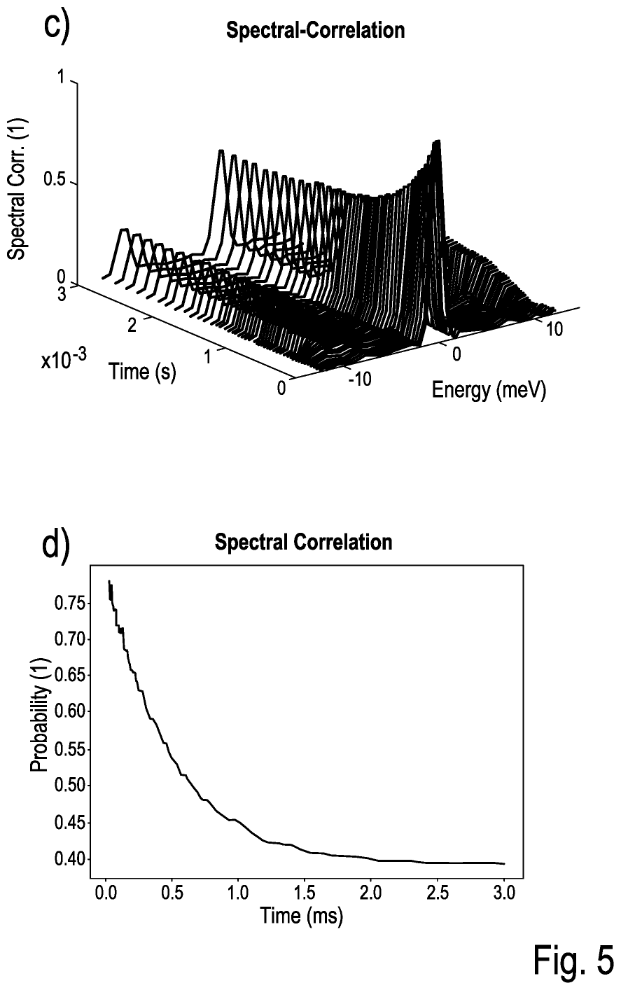

FIG. 5 a schematic illustrating three stages of data analysis;

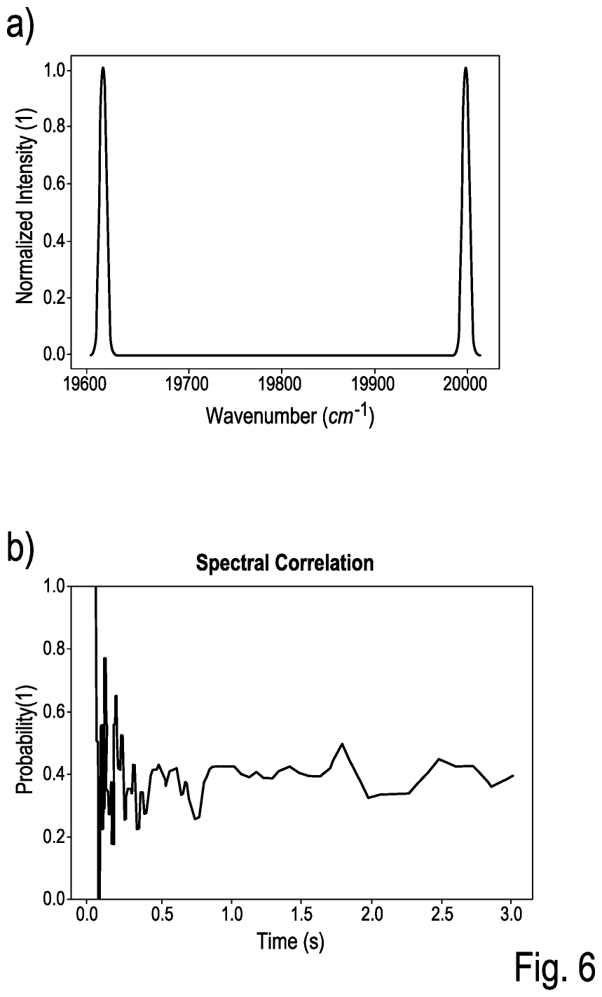

FIG. 6 (a) spectral data of a static doublet and (b) a data analysis (spectral correlation versus time);

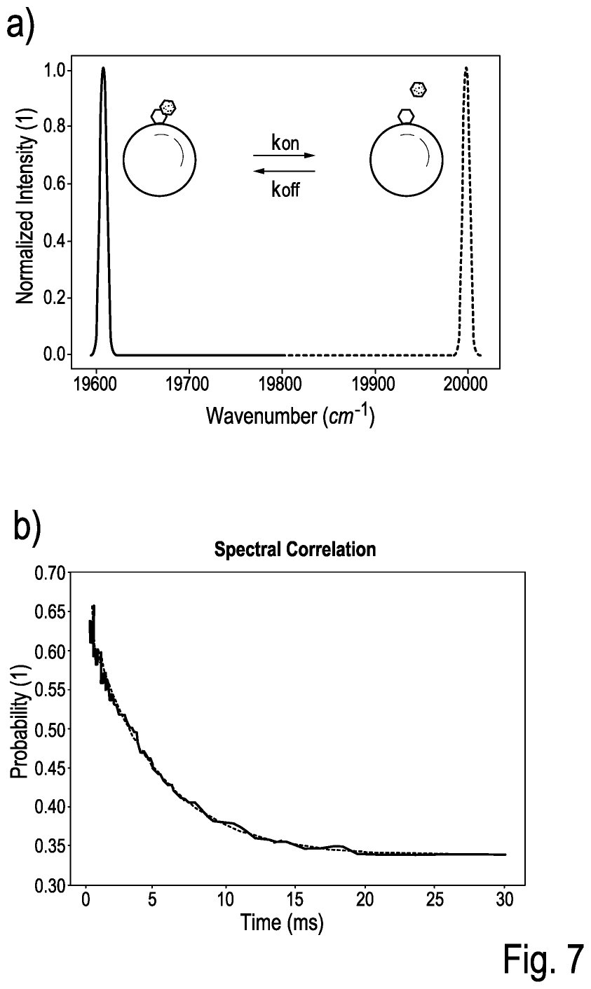

FIG. 7 (a) spectral data of a dynamic doublet and (b) a data analysis (spectral correlation versus time);

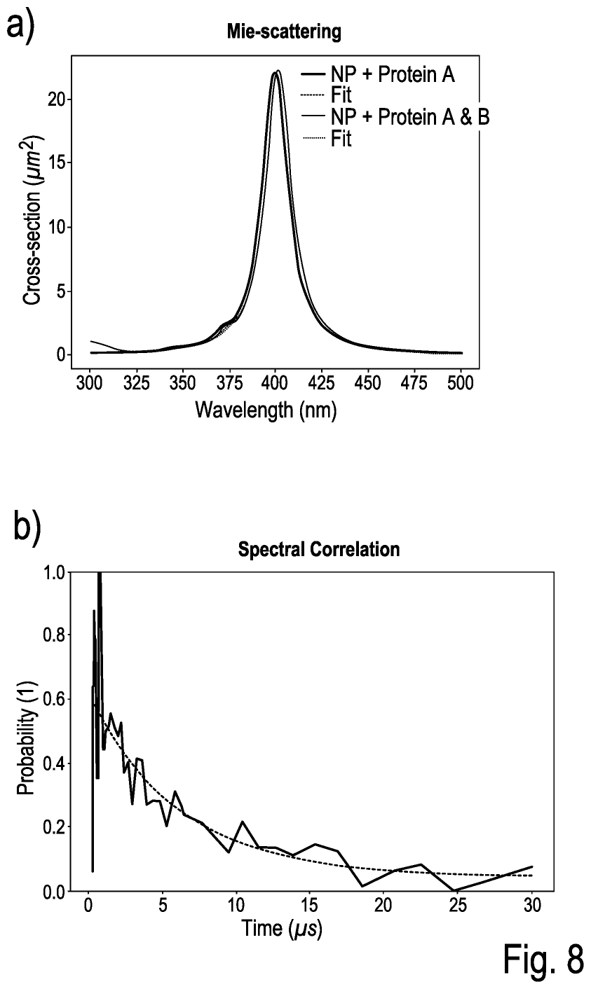

FIG. 8 (a) two state spectra calculated for 50-nm silver nanoparticles with and without a protein (a single layer and two layers of proteins) and (b) a data analysis (spectral correlation versus time);

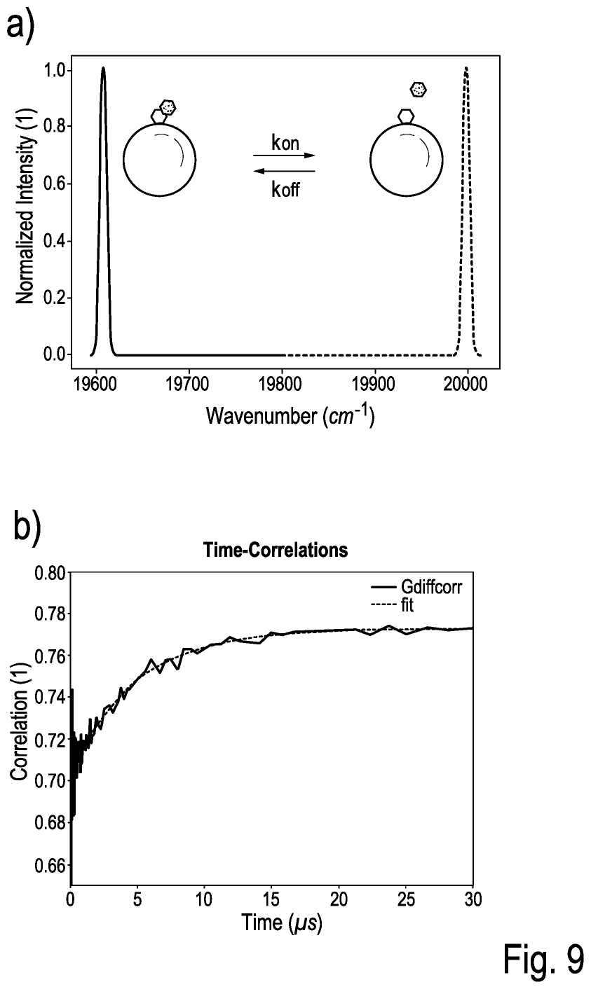

FIG. 9 a static two-state system where only the intensity change is monitored instead of the spectral correlation. (a) The spectrum used for Monte-Carlo sampling and (b) Time correlations versus time;

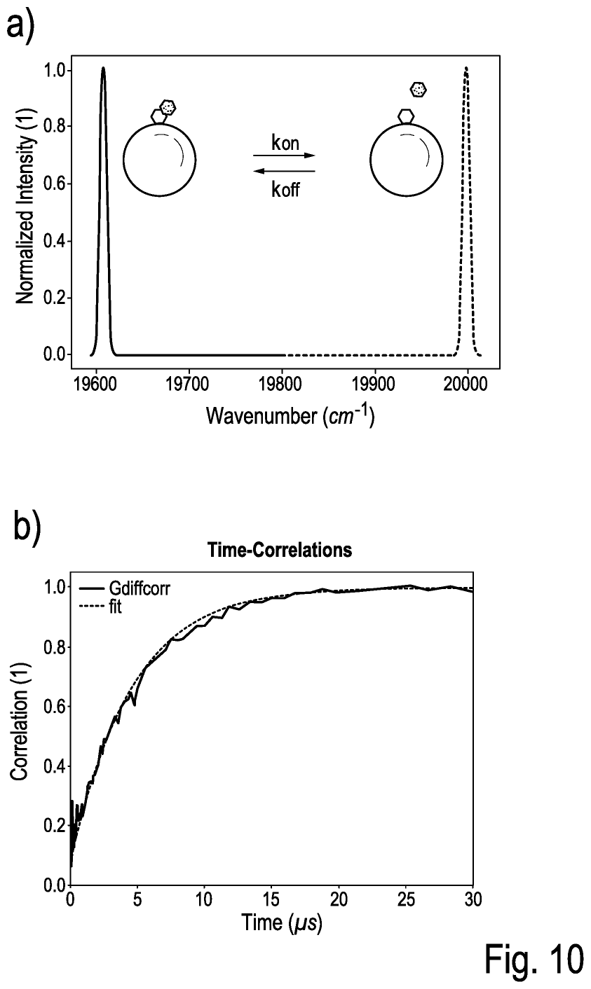

FIG. 10 a static two-state system where the photon numbers are analyzed to detect biomolecular dynamics. (a) The spectrum used for Monte-Carlo sampling. (b) Time correlations versus time; and

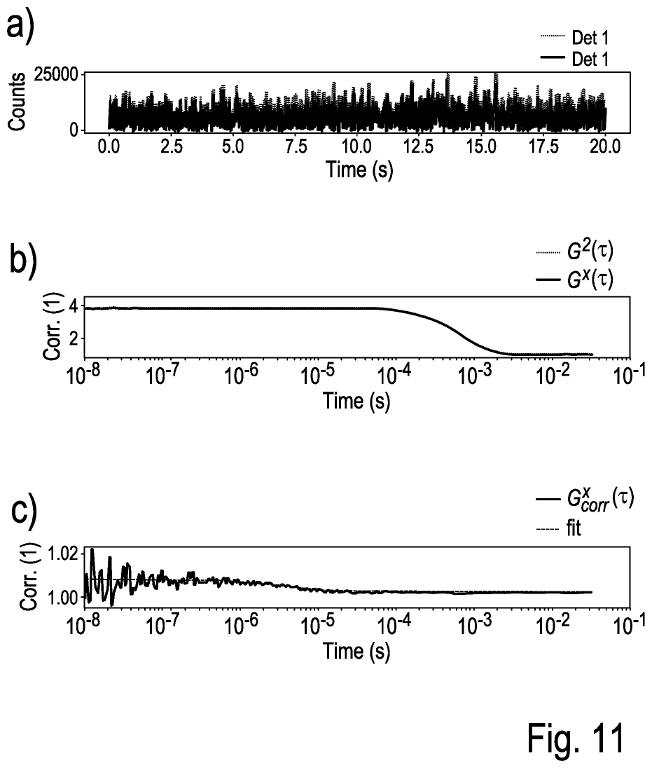

FIG. 11 another schematic further illustrating preferred aspects of the data analysis.

FIG. 1 shows (a) a schematic representation exemplarily illustrating an interaction between biomolecules 1, 2 near the surface of a metallic plasmonic nanoparticle 3 and (b) its effect on the scattering cross-section. In the present example, a first biomolecule 1 is already immobilized on or adherent to the surface of the nanoparticle 3 when a second biomolecule 2 interacts with the first biomolecule 1.

The interaction of the biomolecules 1, 2 near the surface of the nanoparticle 3 can be sensed by making use of a localized surface plasmon resonance (LSPR) “hotspot”, wherein a change of the dielectric environment at the hot-spot results in a shift in the energy of the scattering cross-section of the LSPR.

For this purpose, the nanoparticle 3 is irradiated with first electromagnetic radiation 4, and scattered radiation 5, which is also referred to as “second electromagnetic radiation” in the context of the present disclosure, is detected and analyzed, in particular regarding fluctuations and/or shifts in the energy or wavelengths (also referred to as “spectral shifts”) contained in the detected second electromagnetic radiation 5.

For detecting the scattered radiation and analyzing spectral shifts, interferometric techniques are particularly preferred because of their high spectral sensitivity. However, also non-interferometric approaches implementing, for example, dichroic reflectors and/or filters, can be used.

FIG. 2 shows a schematic representation of an example of an apparatus for characterizing transient interactions between biomolecules. In present example, the apparatus comprises a so-called solution photon-correlation Fourier spectroscopy (S-PCFS) setup, which is based on a photon-correlation interferometry setup (PCFS) which combines confocal microscopy, an interferometer and dual-channel photon-correlation detection. This combination is capable of measuring optical outputs with both high temporal and spectral resolution. For further details regarding PCFS it is referred to Brokmann et al., Photon-correlation Fourier spectroscopy, Optics express, 14(13), 6333-6341 (2006).

In the present example, a radiation source 10, e.g. a laser, in particular a broadband laser, generates first electromagnetic radiation 4 which is directed, for example by means of deflection mirrors 11, 11′, towards an objective 12, by which it is focused to a focal point or focal volume or focal region F located within a sample 13 which comprises a mixture, in particular a solution and/or dispersion, contained in or on a sample holder or receptacle 13a, for example a flat or well plate. In present example, the sample 13 is in the form of a droplet provided on a flat plate. As apparent from the figure, the beam focus F, also referred to as “beam waist”, of the focused first electromagnetic radiation 4 is located at a finite distance above the surface of the flat plate of the receptacle 13a inside the liquid (droplet).

The mixture preferably contains a plurality of plasmonic nanoparticles (see an exemplary nanoparticle 3 located in the focal region F), first biomolecules, second biomolecules and a suitable solvent and/or dispersing agent, e.g. water or buffer. For example, the mixture can be prepared as follows: Proteins of interest A and B, corresponding to the first and second biomolecules, are purified. Plasmonic nanoparticles are synthesized and coated with an appropriate ligand for adherence to protein A. Preferably, the nanoparticles should be stable (i.e. do not dissolve in the solvent or dispersing agent) and non-aggregated. Preferably, the nanoparticles are diluted, e.g. in a well-plate, to concentrations between 1 pM (picomolar) to 1 μM (micromolar), preferably 1 to 10 nM (nanomolar).

Protein A is mixed in solution with the nanoparticles first so that they bind or adhere to the nanoparticles. Protein B is added afterwards. Preparing and measuring different concentrations in different wells is preferred, but not necessary. It is also noted that the mixture can be obtained in different other ways. Preferably, the concentrations of the biomolecules, in particular the proteins, is or are higher than the concentration of the nanoparticles to ensure sufficient interactions between the two.

Preferably, the surface of the holder or receptacle 13a, e.g. a glass surface of the flat or well plate, is chosen such that it does not cause nanoparticles or biomolecules to adhere.

Second electromagnetic radiation 5 scattered by the mixture while being irradiated with the first electromagnetic radiation 4 is directed, for example by deflection mirror 11′, to a beam splitter 14 which splits the second electromagnetic radiation 5 into a first partial beam 5a and a second partial beam 5b. The first partial beam 5a is reflected by a first retroreflector 15a, which is mounted on a, preferably motorized, movable stage 16 by which different path length differences between the first partial beam 5a and the second partial beam 5b can be generated. The second partial beam 5b is reflected by a second retroreflector 15b so as to superimpose with the reflected first partial beam 5a′ at the beam splitter 14. Due to the retro-reflectors 15a and 15b, the reflected first partial beam 5a′ and reflected second partial beam 5b′ have a lateral offset with respect to the first partial beam 5a and second partial beam 5b, respectively. The superposition of the reflected first partial beam 5a′ and reflected second partial beam 5b′ at the beam splitter 14 (at a location which is laterally offset with respect to the impinging second electromagnetic radiation 5) yields a first interference beam 6a and a second interference beam 6b.

Preferably, the stage 16 is slowly moving or scanning during the acquisition so that the path length difference is changing while the second electromagnetic radiation 5 (strictly speaking: the first interference beam 6a and second interference beam 6b) is being detected. In this way, high spectral resolution can be obtained.

Preferably, the movement of the stage 16 is chosen to be slower, preferably much slower, than the timescale of nanoparticle diffusion through the focal volume of the first electromagnetic radiation 4.

The first interference beam 6a and second interference beam 6b are detected separately over time (i.e. at a plurality of different points in time) by means of two separate detectors 7a, 7b, for example single-photon detectors, PMTs or APDs, for each of the path length differences, whereby two series of intensity signals are obtained which represent the intensities of the first interference beam 6a and second interference beam 6b, respectively, at different times and for the different path length differences.

Preferably, a photon time-tagging device 17 which allows for time-correlated single photon counting is provided which is configured to measure the photon time traces for a period of time, e.g. several seconds, for the different positions of the motorized stage 16, i.e. the path length differences. Using single-photon detectors 7a, 7b and/or the photon time-tagging device 17 enables particularly high temporal resolution. As an alternative to the photon time-tagging device 17, a digital correlator can be used.

A processing unit 18 is provided which is configured to statistically analyze and mathematically translate the detected photon time traces or series of intensity signals, respectively, into time and/or spectral correlations. These findings can be fitted with models of interactions between the biomolecules of interest to extract one or more interaction parameters characterizing the interactions, for example the dissociation constant K_{D} and/or the transition rates K_{off} and/or kₒₙ between a bound to an unbound state and vice versa. This will be described in more detail below.

In summary, the S-PCFS setup according to the present example combines the local environment sensitivity of nanoparticle surface-plasmon resonances with the high temporal and spectral resolution inherent to photon-correlation-based interferometry and allows for measuring diffusing nanoparticles with interacting biomolecules on their periphery in solution without selection bias and, therefore, enables the observation of spectral dynamics, in particular free from diffusion effects, on millisecond or even sub-millisecond time-scales on the plasmonic nanoparticles diffusing in solution.

FIG. 3a shows a first example of an alternative setup of an apparatus for characterizing transient interactions between biomolecules by implementing the “dual-color method”, wherein the interferometer, in particular the beam splitter 14, reflectors 15a, 15b and stage 16, of the apparatus shown in FIG. 2 has been exchanged for a dichroic mirror 19, which generates two partial beams 8a, 8b of different spectra (i.e. wavelengths or colors) out of the second electromagnetic radiation 5 impinging the dichroic mirror 19 (i.e. first partial beam 8a has a first spectrum or color and second partial beam 8b has a second spectrum or color which is different from the first spectrum).

Preferably, the spectral position of the dichroic mirror 19 is chosen, such that neither of the two output spectra is dominating in intensity in the unbound case, in which only the first biomolecule(s) adhere(s) to the nanoparticle(s) or, respectively, the second biomolecule(s) is/are not bound to and/or interacting with the first biomolecule(s) adherent to the nanoparticle(s).

Similarly to the apparatus shown in FIG. 2, the two partial beams 8a, 8b are detected separately by separate detectors 7a, 7b over time (i.e. at different time points within a period of time) so as to obtain two series of intensity signals representing intensities of the first partial beam 8a and second partial beam 8b, respectively, at the different times and for the first and second spectrum or color. The change in numbers of photons arriving on each detector 7a, 7b is determined and analyzed preferably by means of a photon time-tagging device 17 and processing unit 18, respectively.

Regarding the other components, in particular radiation source 10, mirrors 11, 11′, objective 12 and receptacle 13a, and functionality of the apparatus shown in FIG. 3, the explanations above regarding the apparatus shown in FIG. 2 apply accordingly.

As an alternative to the dichroic mirror 19, which advantageously provides a very high signal-to-noise ratio, the dichroic mirror 19 can be replaced by any other spectral splitting element which is configured to isolate intensities on one and the other side of the spectrum, i.e. to provide the two partial beams 8a, 8b of different spectra out of the second electromagnetic radiation 5. For example, the dichroic mirror 19 can be replaced by a beam splitter and two band-pass filters or short- and long-pass combination or by two monochromators.

FIG. 3b shows a second example of an alternative setup of an apparatus for characterizing transient interactions between biomolecules by implementing the “dual-color method”, wherein a dichroic mirror 19 is not only acting as a spectral splitting element but also as a beam splitting element and, therefore, generates two partial beams 8a, 8b of different spectra (i.e. wavelengths or colors) out of the second electromagnetic radiation 5 impinging the dichroic mirror 19. Regarding the detection of the partial beams 8a, 8a and the other components, in particular radiation source 10, mirrors 11, 11′, objective 12 and receptacle 13a, and functionality of the apparatus shown in FIG. 3b, the explanations above regarding the apparatus shown in FIGS. 2 and 3a apply accordingly.

FIG. 3c shows a third example of an alternative setup of an apparatus for characterizing transient interactions between biomolecules by implementing the “dual-color method”, wherein the dichroic mirror 19 (see FIGS. 3a and 3b) has been replaced by a beam splitter 14, which splits the second electromagnetic radiation 5 into a first partial beam 5a and a second partial beam 5b, and two different band-pass filters 19a and 19b, which are configured to transmit different spectra so as to generate two filtered partial beams 8a, 8b of different spectra (i.e. wavelengths or colors) out of the second electromagnetic radiation 5. Regarding the detection of the filtered partial beams 8a, 8b and the other components, in particular radiation source 10, mirrors 11, 11′, objective 12 and receptacle 13a, and functionality of the apparatus shown in FIG. 3c, the explanations above regarding the apparatus shown in FIGS. 2 and 3a apply accordingly.

### General Considerations

In order to illustrate some basic considerations regarding the relationship between spectral shift and spectral correlation as a function of time, the spectral dynamics for a spectrally shifting laser beam can be examined on a system which does not necessarily require nanoparticles and biomolecules but is rather mimicking a signal similar to sensing biomolecules. In an exemplary setup, a tunable laser is used with a 1 nm broad spectral linewidth. This spectrum is then periodically tuned from 540 nm to 545 nm, with the timescale of tuning expected to be 140 ms. This light is measured using a PCFS setup described above.

FIG. 4 shows (a) the spectral data, i.e. the spectral switching, from the tunable laser which is detected using the PCFS setup and (b) a data analysis which reveals that the spectrum is shifting, i.e. periodically switching, at a timescale of 140 ms, as expected.

### Analysis of the Data

Preferably, the data obtained by the setups according to present disclosure are analyzed by looking into the photon time streams, which are also referred to as “intensity signals” or “series of intensity signals”. Preferably, the streams are separated into three streams: a “Total stream”, “Detector 1 stream”, and “Detector 2 stream”.

On the Total stream, the time auto-correlation is performed, which reflects the nanoparticle diffusion.

For Detector streams 1 and 2, the time cross-correlation is calculated. This will reveal any spectral dynamics at play, thus also the transient binding behavior. Note however, that this data may still contain particle diffusion dynamics which may also need to be considered. Preferably, this can be corrected with the diffusion dynamics information that is obtained from the Total stream, isolating the biomolecular dynamics of the system.

Preferably, the cross-correlation from A*B and B*A is calculated, wherein A and B correspond to the “Detector 1 stream” and “Detector 2 stream”, respectively. Theoretically, these are the same. But because of the use of speed-up algorithms there may occur a slight mismatch between these two. The average/mean of both A*B and B*A then is used as the cross-correlation.

Next, this same analysis is performed for all coarse path-length differences in the measurement, yielding a 3-dimensional data set with path-length difference, time and correlation as axes, wherein the time given along the time axis corresponds to the time lag from the correlation operation. The auto- and cross-correlations as mentioned before are nothing more than sections with fixed path-length difference. However, when a section with fixed time is taken, it is possible to measure the envelope of the interferogram.

Lastly, spectral information can be gained from all of this by Fourier transforming the interferogram to give the spectral correlation. The spectral information can also be presented in 3D, because the interferograms exist as functions of energy (wavelengths) and time. Therefore, the spectral correlation change as a function of time can be seen. These changes can be fit to an exponential decaying function to extract the relevant biomolecular dynamic information. It is noted that, as an alternative to an exponentially decaying function, it can be any function that reflects the underlying dynamics.

FIG. 5 illustrates the three stages of data analysis: (a) Photon streams measured at each interferometer arm position (different colors) are time-correlated. (b) A slice through the 3D dataset for a given time gives the PCFS interferogram. (c) The Fourier transform of the interferogram yields the spectral correlation. (d) Analysis of the temporal change of the spectral correlation reveals biomolecular dynamics.

Further details and explanation of the preferably performed data analysis is given below with reference to FIG. 11, which illustrates more realistic simulation taking into account nanoparticle diffusion and nanoparticle optical properties.

### Computational Model

Preferably, biomolecular interactions occurring in the proximity of the sensing nanoparticles can be simulated by means of a computational model. A simple binary interaction can be described by a two-state model, where the biomolecules are either attached or detached with forward and backwards rates dictating the time-scale of change.

A+B [symbol] A·B

A simulation can mimic this system by defining two distinct peaks in the spectrum, one corresponding to the “on state” and the other to the “off state”. Next, time dynamics is instituted by performing Monte Carlo sampling from either peak of the spectrum while reflecting the typical time dynamics of the interaction.

### Static Doublet

As a first check, a sample is considered with the two states existing in equal proportion and static across all timescales, and thus showing no time dynamics. The spectrum with two states, used in the simulation, is shown in FIG. 6a. The resulting spectral correlation from the simulated measurement shows no change with time, as seen by the nearly flat line in FIG. 6b. As illustrated in FIG. 6, (a) a two-state system without any time dynamics can be modeled as two static spectral lines, and (b) an analysis of the spectral correlation shows no time dynamics present in the system, as expected.

### Dynamic Doublet

Next, a similar model system can be analyzed, but this time including dynamics. In this simulation, photons coming from either one of the two distinct peaks are sampled as a function of time. The timescale of transition is dictated by the rate constants kₒₙ and k_{off}. When the rate equation is solved, it can be shown that there is an exponentially decaying probability of switching between the two states. A measurement can easily measure this exponential decay, and after fitting, it can be retrieved that, as expected, the typical transition time is governed by the sum of kₒₙ and k_{off}. In this case, kₒₙ and k_{off} are both set to 1·10⁵ s⁻¹, and from the fit, 2.04·10⁵ s⁻¹ is retrieved for their sum. Additionally, the long-timescale asymptotic value is governed by K_{d} in the form of

$$\frac{1 + {K}_{d}^{2}}{{( 1 + {K}_{d} )}^{2}} .$$

From a single measurement, it may not always be possible to uniquely determine kₒₙ, k_{off}, and K_{d}. Therefore, it is preferred to provide a concentration series (i.e. at least two mixtures having different concentrations of biomolecules) which will enable the quantification of both rates and the dissociation constant for transient biomolecular dynamics even on sub-millisecond timescales. Preferably, nanoparticle concentration stays the same.

The method and apparatus according to present disclosure are limited in time resolution by the signal-to-noise ratio that can be obtained at increasingly shorter timescales. Unlike in fluorescence, however, the obtainable signal-to-noise ratios can potentially be much higher at fast timescales because of the number of photons generated by the inherently fast scattering processing of localized surface plasmon resonances. In this case, the temporal resolution is limited by the resolution of the single-photon detectors and the hardware correlator, i.e. the photon time-tagging device 17, which is on the order of nanoseconds. This provides sensitivity to even the fastest of biomolecular interactions.

As illustrated in FIG. 7, (a) for a dynamic two-state system, photons coming from either one of the two distinct peaks, representing two different states, are sampled as a function of time. This timescale is dictated by the rates kₒₙ and k_{off}. (b) The spectral correlation shows the expected timescale of the switching between the two states.

### Dynamic Doublet Considering Plasmonic Particles with Proteins

The previous results show that even the fastest-timescale dynamics for a biomolecular state-switching system are measurable with the setup according to present disclosure.

Considering that these results were obtained on a very simplistic model with arbitrarily defined spectra to reflect the sensitivity of the nanoparticles, the model is preferably refined by considering more “realistic” values based on electromagnetic simulations of the optical response of spherical nanoparticles.

It is noted that spheres are not the only nanoparticles that can be used. Other nanoparticle shapes can also be used and some preferred.

FIG. 8 (a) shows two extinction spectra for silver spheres with diameter 50 nm calculated using the electromagnetic “Mie theory”. To mimic sensing, in a first state one particle is surrounded by a first protein layer of 4 nm, while a second state consists of a particle surrounded by two layers of proteins forming a 8 nm shell around it, with switching occurring at the same transition rates as in FIG. 7. From this simplistic system, the expected timescales of the dynamics of this system can still be easily extract (FIG. 8 (b)). From the fit, 1.6·10⁵ s⁻¹ for the sum of kₒₙ and k_{off} is retrieved. The slight deviation from the expected value comes from the deviation in the fit, which can be attributed to noise in the signal from the limited number of photons that we simulated for computational speed.

### Preferred Adaptations to the S-PCFS Method

The method and apparatus described above can be adapted, for example, in order to reduce the duration of the measurement, which is typically on the timescale of tens of minutes, in order to enable measuring many different samples in an acceptable time. Approaches intended to overcome these limitations are described as follows.

### Single-Point PCFS

This preferred embodiment does not rely on resolving a complete interferogram as is the case with PCFS. Here, one point of the interferogram is chosen, where contrast due to dynamics (potentially highest on the steepest part of the interferogram) is expected. This time, the contrast change of the interferogram is measured rather than the spectral change.

FIG. 9 illustrates a static two-state system where only the interferometric change is monitored instead of the spectral correlation, wherein a) shows the spectrum used for Monte-Carlo sampling and b) the interferometric change showing the same system dynamics as in FIG. 7. As apparent from FIG. 9, it is possible to extract the same dynamics from the same system as in FIG. 7. From the fit, 2.03·10⁵ s⁻¹ for the sum of kₒₙ and k_{off} can be retrieved, as expected.

### Fixed-Point Interferometry

This preferred embodiment is relatively similar to the single point PCFS. However, in this method interferometric contrast over one static point in the interferogram is analyzed. This method is more similar to traditional Fourier spectroscopy than to PCFS. The advantage of this method is that it not only shows interferometric contrast, but also shows effects from the fringes in the interferogram, opening up to measurement of the absolute wavelength of the spectrum.

### Dual-Color Method

This preferred approach, which is already described above with reference to FIG. 3, does not rely on any interferometric effects. Here, the interferometer is exchanged with a dichroic mirror positioned in between the middle of the two states. In this case, the change in numbers of photons arriving on either detector has to be computed. This number then reflects biomolecular dynamics. From the fit, 2.26·10⁵ s⁻¹ for the sum of kₒₙ and k_{off} can be retrieved.

FIG. 10 illustrates a static two-state system where the photon numbers are analyzed to detect biomolecular dynamics. a) The spectrum used for Monte-Carlo sampling. b) The biomolecular dynamics can be extracted from photon counting analysis.

FIG. 11 shows a schematic to further illustrate a preferably performed data analysis of nanoparticle scattering spectra switching between two states. In short, FIG. 11a) shows the time trace signal as measured on the two detectors “Det 1” and “Det 2” (see, e.g. detectors 7a and 7b in FIGS. 2 and 3a to 3c). For inspection, the TCSPC/Time-tagged data has been binned into equal time containers. FIG. 11 b) shows the computed auto- and cross-correlations, g²(τ) and g^{x}(τ), respectively. FIG. 11 c) shows the corrected cross-correlation which is computed from g² (τ) and g^{x}(τ). By means of fitting (see “fit”), the relevant interaction parameters (kₒₙ, k_{off}, K_{D}) can be extracted.

More specifically, the data analyzed comes from the photon counts registered on both detectors. Preferably, these counts are time-tagged data, but do not necessarily have to be. The data from the two detectors can be separated into three photon streams: Detector 1 stream, Detector 2 stream, and the Total (Det 1+Det 2) stream. First, a time auto-correlation g²(τ)is computed from the total photon stream. The resulting curve reflects the nanoparticle/sensor diffusion. Then, time cross-correlations g^{x}(τ) are computed for both detector stream 1 and 2. Finally, both curves are averaged together via (g*(τ)=(g_{Det 1}^{x}(τ)+g_{Det 1}^{x}(τ))/2), because they should output approximately the same signal. This time cross-correlation gives insight into any spectral dynamics at play, or in other words, transient binding events around the sensor. Note however, that the cross-correlation still contains particle diffusion dynamics. Therefore, the cross-correlation is preferably corrected with the time auto-correlation of the total stream, thereby isolating the nanoparticle sensing dynamics of the system:

g_{corr}^{x}(τ)=−2(g^{x}(τ)/g²(τ)−1)+1

The above-mentioned formula shows that the correction is made by dividing out the time auto-correlation of the total stream. The additional factors are needed for proper scaling.

FIG. 11 illustrates the working principle of this analysis based on simulated data coming from diffusing nanoparticles, having a spectrum that switches between two states with kₒₙ=K_{off}=1·10⁵ s⁻¹. In FIG. 11 a), the obtained time-tagged data from the two detectors is shown as time-binned histograms. This is merely to visualize what the detected signal looks like. FIG. 11 b) shows the computed time auto-correlation of the total stream and the average time cross-correlation of detector 1 and detector 2. Lastly, FIG. 11 c) shows the corrected cross-correlation, g_{corr}^{×}(τ), following the equation above. Here, it can be observed that in the corrected cross-correlation, the spectral dynamics have been isolated, and nanoparticle diffusion dynamics have been removed completely. Therefore, by fitting this corrected curve with an exponential function, the desired interactions parameters kₒₙ, and k_{off}, and K_{D} can be extracted. In present example, kₒₙ=1.08·10⁵ s⁻¹, k_{off}=1.08·10⁵ s⁻¹, and K_{D}=½ is retrieved.

1. A method for characterizing transient interactions between biomolecules comprising following steps:
providing a plurality of plasmonic nanoparticles which are configured to allow first biomolecules to adhere thereto,
providing a mixture comprising the nanoparticles, first biomolecules and second to allow the first biomolecules to adhere to the nanoparticles and to allow the second biomolecules to, in particular transiently, interact with the first biomolecules adherent to the nanoparticles,
irradiating the mixture with first electromagnetic radiation, in particular broadband electromagnetic radiation,
detecting second electromagnetic radiation, which is scattered by the mixture while irradiating the mixture with the first electromagnetic radiation, in a time-resolved and spectrally-resolved manner so as to obtain intensity signals representing changes in the spectrum of the detected second electromagnetic radiation, and
determining at least one interaction parameter characterizing transient interactions of the second biomolecules with the first biomolecules based on the intensity signals.

2. The method according to claim 1, wherein the step of detecting the second electromagnetic radiation comprises
splitting the second electromagnetic radiation into a first partial beam and a second partial beam,
providing one or more different path length differences between the first partial beam and the second partial beam,
superimposing the first partial beam and the second partial beam for each of the path length differences so as to obtain a first interference beam and a second interference beam for each of the path length differences, and
separately detecting the first interference beam and the second interference beam by means of two separate detectors at different times and for each of the path length differences so as to obtain two series of intensity signals representing intensities of the first interference beam and second interference beam, respectively, at the different times and for the different path length differences.

3. The method according to claim 1, wherein the step of detecting the second electromagnetic radiation comprises
applying the second electromagnetic radiation to at least one spectral splitting element, in particular a dichroic optical element, so as to obtain at least one first partial beam of electromagnetic radiation having a first spectrum and at least one second partial beam of electromagnetic radiation having a second spectrum which is different from the first spectrum, and
separately detecting the first partial beam and the second partial beam by means of two separate detectors at different times so as to obtain two series of intensity signals representing intensities of the first partial beam and second partial beam, respectively, at the different times and for the first and second spectrum.

4. The method according to claim 2 further comprising determining at least one time auto-correlation function (intensity-time auto-correlation function) characterizing a time auto-correlation of a combination of the two series of intensity signals, wherein at least one diffusion parameter characterizing a diffusion of the nanoparticles in the mixture is determined based on the at least one time auto-correlation function.

5. The method according to claim 2 further comprising determining at least one time cross-correlation function (intensity-time cross-correlation function) characterizing a time cross-correlation between the two series of intensity signals, wherein the at least one interaction parameter is determined based on the at least one time cross-correlation function and optionally also on the at least one time autocorrelation function.

6. The method according to claim 4, wherein the at least one time auto-correlation function and/or the at least one time cross-correlation function is determined for the different path length differences between the first partial beam and the second partial beam or for the first and second spectrum, respectively.

7. The method according to claim 4, wherein the time auto-correlation function (intensity-time auto-correlation function) is used to correct the time cross-correlation function (intensity-time cross-correlation function) to remove effects of nanoparticle diffusion on the time cross-correlation function.

8. The method according to claim 7, wherein the at least one interaction parameter is determined based, in particular based only, on the corrected intensity cross-correlation function.

9. The method according to claim 5 further comprising Fourier transforming the time cross-correlation functions, which are determined for the different path length differences, with respect to the dimension of the path length differences so as to obtain spectral correlation functions (spectral-time correlation function) at different times and for different wavelength changes, wherein the at least one interaction parameter is determined based on the spectral correlation functions.

10. The method according to claim 9 further comprising determining a temporal behavior of the spectral correlation functions, wherein the at least one interaction parameter is determined based on the temporal behavior of the spectral correlation functions and/or intensity correlation functions.

11. The method according to claim 1, wherein determining the at least one interaction parameter includes determining at least one parameter characterizing reversible interactions between the first and second biomolecules.

12. The method according to claim 1, wherein determining the at least one interaction parameter includes determining at least one of the following:
a first transition rate characterizing a time rate at which transitions occur between an unbound state, in which the second biomolecules are not bound to and/or do not interact with first biomolecules, to a bound state, in which the second biomolecules are bound to and/or interact with the first biomolecules, and/or a second transition rate characterizing a time rate at which transitions occur between a bound state, in which the second biomolecules are bound to and/or interact with the first biomolecules, to an unbound state, in which the second biomolecules are not bound to and/or do not interact with the first biomolecules, and/or
a dissociation constant characterizing a tendency of the first and second biomolecules to reversibly dissociate between a bound state, in which the second biomolecules are bound to and/or interact with the first biomolecules, and an unbound state, in which the second biomolecules are not bound to and/or do not interact with the first biomolecules.

13. The method according to claim 1, wherein the mixture comprising the nanoparticles, first biomolecules and second biomolecules is a solution and/or dispersion, wherein the nanoparticles, first biomolecules and second biomolecules are dissolved in a solvent or dispersed in a dispersion agent, respectively.

14. An apparatus for characterizing transient interactions between biomolecules comprising:
a receptacle configured to receive a mixture comprising first biomolecules, second biomolecules and a plurality of plasmonic nanoparticles which are configured to allow at least a part of the first biomolecules to adhere thereto, wherein at least a part of the second biomolecules are allowed to, in particular transiently, interact with first biomolecules adherent to the nanoparticles,
an irradiation unit configured to irradiate the mixture with first electromagnetic radiation, in particular broadband electromagnetic radiation,
a detection unit configured to detect second electromagnetic radiation, which is scattered by the mixture while being irradiated with the first electromagnetic radiation, in a time-resolved and spectrally-resolved manner so as to obtain intensity signals representing changes in the spectrum of the detected second electromagnetic radiation, and
a processing unit configured to determine at least one interaction parameter characterizing transient interactions of the second biomolecules with the first biomolecules based on the intensity signals.

15. The apparatus according to claim 14, wherein the first electromagnetic radiation is configured to cause and/or excite a surface plasmon resonance of the nanoparticles.

16. The apparatus according to claim 15, wherein one or more wavelengths or energies of the first electromagnetic radiation match one or more wavelengths or energies, respectively, of the surface plasmon resonance.

17. The apparatus according to claim 14, wherein the detection unit comprises:
a beam splitter configured to split the second electromagnetic radiation into a first partial beam and a second partial beam,
a path length difference generating unit configured to provide one or more different path length differences between the first partial beam and the second partial beam, wherein the first partial beam and the second partial beam are allowed to superimpose for each of the path length differences so as to obtain a first interference beam and a second interference beam for each of the path length differences, and
two separate detectors which are configured to separately detect the first interference beam and the second interference beam at different times and for each of the path length differences so as to obtain two series of intensity signals representing intensities of the first interference beam and second interference beam, respectively, at the different times and for the different path length differences.

18. The apparatus according to claim 14, wherein the detection unit comprises:
at least one spectral splitting element, in particular a dichroic optical element, configured to reflect and/or transmit the second electromagnetic radiation so as to obtain at least one first partial beam of electromagnetic radiation having a first spectrum and at least one second partial beam of electromagnetic radiation having a second spectrum which is different from the first spectrum, and
two separate detectors which are configured to separately detect the first partial beam and the second partial beam at different times so as to obtain two series of intensity signals representing intensities of the first partial beam and second partial beam, respectively, at the different times and for the first and second spectrum.

19. The apparatus according to claim 18, wherein the at least one spectral splitting element, in particular the dichroic optical element, is configured to reflect and/or transmit the second electromagnetic radiation such that one or more wavelengths or frequencies of the first spectrum and/or of the second spectrum match one or more wavelengths or energies, respectively, of the surface plasmon resonance.

20. A system for characterizing transient interactions between biomolecules, the system comprising the apparatus according to claim 14 and
a plurality of plasmonic nanoparticles which are configured to allow first biomolecules to adhere thereto and/or
a mixture comprising a plurality of plasmonic nanoparticles, which are configured to allow first biomolecules to adhere thereto, first biomolecules and second biomolecules.
